(19) United States
(12) Patent Application Publication
(10) Pub. No.: US 2015/0229641 A1
(43) Pub. Date: Aug. 13, 2015

(54) MIGRATION OF A SECURITY POLICY OF A VIRTUAL MACHINE

(71) Applicant: Hangzhou H3C Technologies Co., Ltd., Hangzhou (CN)

(72) Inventors: Songer Sun, Beijing (CN); Zhenfeng Lv, Beijing (CN)

(21) Appl. No.: 14/372,727

(22) PCT Filed: Nov. 26, 2012
(86) PCT No.: PCT/CN2012/085239

§ 371 Date: Jul. 16, 2014

(30) Foreign Application Priority Data
Apr. 23, 2012 (CN) 201210121457.9

(51) Int. Cl. H04L 29/06; G06F 9/50; G06F 9/455

(52) U.S. Cl. CPC H04L 63/0876; G06F 9/45558; G06F 9/5027; H04L 63/20; G06F 2009/4557; G06F 2209/5013

(57) ABSTRACT

According to an example, an apparatus for Virtual Machine (VM) security policy migration includes a migration detecting module, a locating module and a security policy managing module. The migration detecting module is to receive a VM migration report from a VM management apparatus, wherein the VM migration report includes a location parameter of a VM. The locating module is to determine, according to the location parameter of the VM and a locating function, an old security device and a new security device that the VM belongs to before and after the migration. If the old security device and the new security device are not the same security device, a notification is transmitted to the security policy managing module, and a security policy of the VM on the old security device is issued to the new security device.

### BACKGROUND

With the development of the Internet, virtualization techniques have been widely applied in various layers of data centers. A virtualization technique may create multiple independent Virtual Machines (VMs) on one physical server. Each VM may act as an independent server. Similar as the physical server, the VM also has its own Internet Protocol (IP) address and Media Access Control (MAC) address, and also has an operating system and various application programs.

Most popular virtualization techniques support migration, or even online migration, of a VM between different physical servers, wherein the online migration ensures that services provided by the VM is not interrupted during the migration.

### BRIEF DESCRIPTION OF THE DRAWINGS

Features of the present disclosure are illustrated by way of example and not limited in the following figure(s), in which like numerals indicate like elements, in which:

FIG. 1 is a schematic diagram illustrating the migration of a VM according to an example of the present disclosure.

FIG. 2 is a schematic diagram illustrating the migration of a VM according to another example of the present disclosure.

FIG. 3 is a schematic diagram illustrating a structure of a VM security policy migration apparatus according to an example of the present disclosure.

FIG. 4 is a flowchart illustrating a method of VM security policy migration according to an example of the present disclosure.

FIG. 5 is a schematic diagram illustrating another structure of a VM security policy migration apparatus according to an example of the present disclosure.

FIG. 6 is a schematic diagram illustrating another structure of a VM security policy migration apparatus according to an example of the present disclosure.

### DETAILED DESCRIPTION

Hereinafter, the present disclosure is described in further detail with reference to the accompanying drawings and examples.

For simplicity and illustrative purposes, the present disclosure is described by referring to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on. In addition, the terms “a” and “an” are intended to denote at least one of a particular element.

An example of the present disclosure provides a VM security policy migration apparatus. The VM security policy migration apparatus includes: a migration detecting module, a locating module and a security policy managing module. The migration detecting module is to receive a VM migration report from a VM management apparatus, wherein the VM migration report includes at least a location parameter of the VM, and the VM management apparatus is to create and manage the VM. The locating module is to determine, according to the location parameter of the VM and a locating function, an old security device that the VM belongs to before migration and a new security device that the VM belongs to after the migration, determine whether the old security device and the new security device are the same security device, and transmit a notification to the security policy managing module if the old security device and the new security device are not the same security device. The security policy managing module is to obtain, after receiving the notification transmitted by the locating module, a security policy of the VM configured on the old security device and issue the security policy to the new security device.

In an example of the present disclosure, seamless migration of the security policy of the VM on the security device can be realized along with the migration of the VM utilizing the VM security policy migration apparatus.

In an example of the present disclosure, the migration of the security policy is realized by cooperation of the VM management apparatus and the VM security policy migration apparatus. Hereinafter, detailed implementations are provided with reference to accompanying drawings.

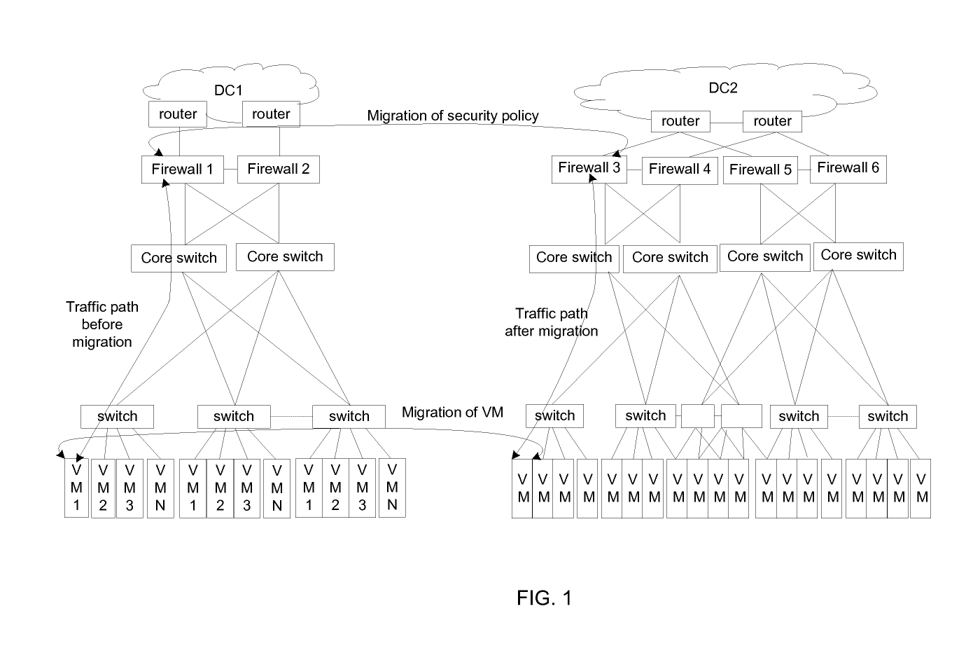

Most large users (e.g., various Internet companies) configure a plurality of Data Center (DC) sites (e.g., DC1 and DC2 shown in FIG. 1) at different spots. Servers of each DC site may be managed by a VM management apparatus. The VM management apparatus may comprise a software program running on an independent server. The VM management apparatus is able to create and manage one or a batch of VMs. The creation and management includes: assigning various kinds of underlying hardware resources including CPU and various kinds of software resources for the VM, configuring and managing various kinds of network attributes of a port that the VM belongs to, e.g., Profile rules such as VLAN ID and QoS policies for the VM. After being created, a VM is ready to provide services through network. As shown in FIG. 1, in one example of the present disclosure, the VMs access, through access layer switches and aggregation layer switches, security devices (e.g., firewalls) and further external networks (e.g., the Internet).

Security policies are configured corresponding to the VMs on the security devices, so as to ensure that the communication from an interior network to an external network is controllable, especially to avoid attacks from the external network. The firewall is taken as an example of a security device. The security policies cover very broad categories. A simple security policy may be an IP address filtering function that all firewalls have. The IP address filtering function includes: checking an IP packet header, determining to forward or discard a packet according to a source IP address and a destination IP address. For current popular firewalls, the security policies on the network layer include any combination of source IP address, destination IP address, protocol type, source port, and destination port. Many firewalls also have application layer security policies, e.g., filtering packets according to application names or special fields in protocol packet loads, or according to factors such as a Time To Live (TTL) value or a source domain name. The network layer security policies and the application layer security policies may be used in combination. Since different VMs may provide different services, administrators may configure different security policies for different VMs on the security device. The implementation of the present disclosure is not restricted by the detailed contents of the security policies.

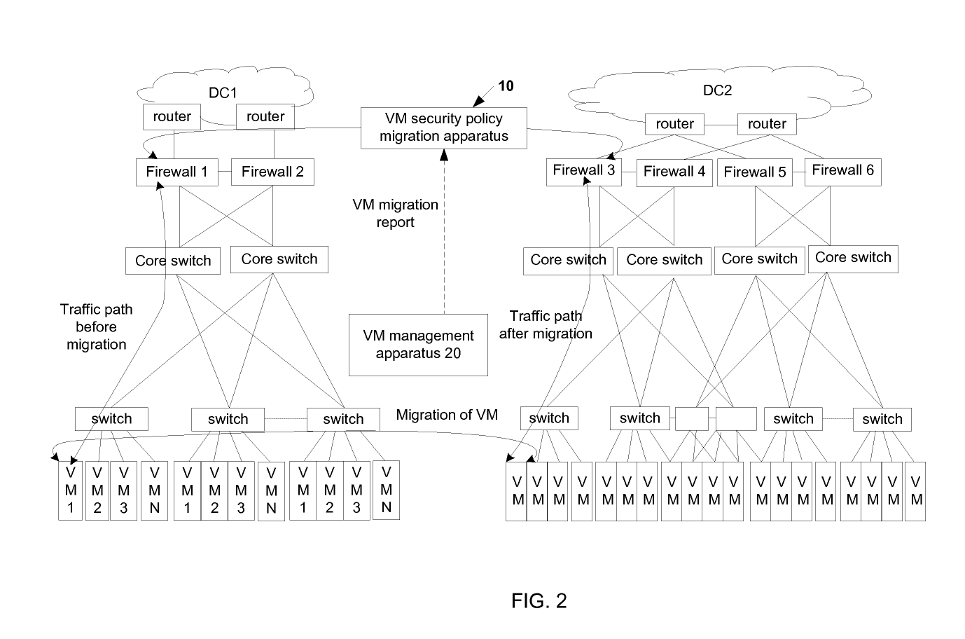

During the management of the data centers, VMs may be migrated due to various reasons. For example, servers hosting VMs may be decommissioned, or new servers may be added, and as a result, VMs may be migrated. For example, as shown in FIG. 2, a VM is migrated from a server of DC1 to another server of DC2 by the VM management apparatus 20 through configuring a migration policy of the VM. In an example of the present disclosure, after receiving a VM migration report transmitted by the VM management apparatus 20, the VM security policy migration apparatus 10 detects the migration of the VM and then finishes the migration of the security policy.

Hereinafter, the seamless migration of the security policy on the security device along with the migration of the VM under the cooperation of the VM security policy migration apparatus 10 and the VM management apparatus 20 is described in detail with reference to the accompanying drawings. It should be noted that, the present disclosure is not restricted to the migration of the VM between different data centers and is applicable for VM migration within the same data center (there may be a plurality of security devices in one data center) or in other environments.

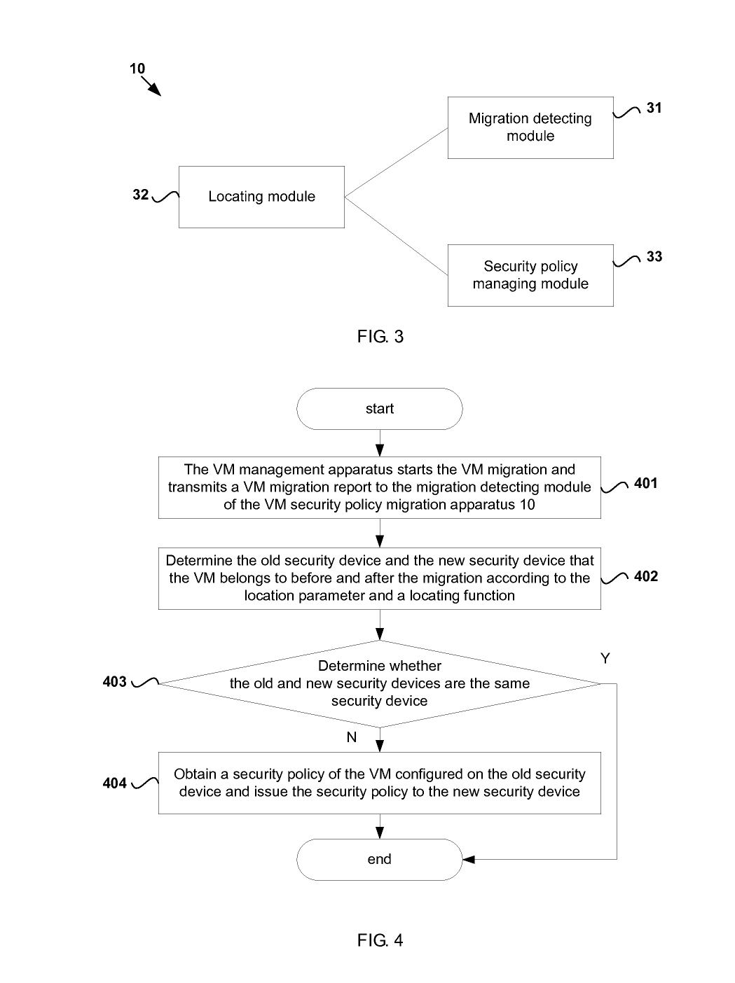

FIG. 3 is a schematic diagram illustrating a structure of a VM security policy migration apparatus 10 according to an example of the present disclosure. As shown in FIG. 3, the VM security policy migration apparatus 10 includes: a migration detecting module 31, a locating module 32 and a security policy managing module 33.

The migration detecting module 31 is to receive a VM migration report transmitted by the VM management apparatus, wherein the VM migration report includes at least a location parameter of the VM, and the VM management apparatus is to create and manage the VM.

The locating module 32 is to determine, according to the location parameter of the VM and a location function, an old security device that the VM belongs to before the migration and a new security device that the VM belongs to after the migration, determine whether the old security device and the new security device are the same security device, and transmit a notification to the security policy managing module 33 if the old security device and the new security device are not the same security device.

The security policy managing module 33 is to obtain, after receiving the notification from the locating module 32, a security policy of the VM configured on the old security device, and issue the security policy to the new security device.

These modules may be implemented by software (e.g., machine readable instructions stored in a memory and executable by a processor), hardware (e.g., the processor or an ASIC), or a combination thereof.

In an example of the present disclosure, the VM security policy migration apparatus 10 is located in a security management server. The security management server is a server for managing the security devices.

Hereinafter, detailed functions of the above modules are described with reference to FIG. 4 which is a flowchart illustrating a method of VM security policy migration according to an example of the present disclosure. As shown in FIG. 4, the method includes the following operations.

At block 401, the VM management apparatus starts the VM migration and transmits a VM migration report to the migration detecting module 31 of the VM security policy migration apparatus 10.

In this example, the VM migration report may be transmitted at different times, e.g., after the migration is completed, or before the migration is started or during the migration. In one example of the present disclosure, the VM migration report may be transmitted after the migration is completed. Although this may affect the timely service providing of the VM to some extent, since the subsequent security policy migration is completed automatically, the migration required a very short time, the impact is limited. Also, the transmission after the migration may avoid fault migration of security policies due to unsuccessful migration of the VM.

The VM migration report includes at least a location parameter of the VM.

The location parameter may include one or more of: an IP address of the VM, a MAC address of the VM, IP addresses of a physical server before and after the migration, access port IDs of the VM before and after the migration, and a VLAN ID of the VM. The VM migration report may be carried by any kind of private or public protocol packets. In one example, the VM migration report may adopt a Java Script Object

Notation (JSON) format. The detailed contents of the VM migration report may be as follows:

{“Version”: “1.0”, “Type”:1, “Src_Host_IP”: “192.168.0.1”, “Src_Host_Name”: “src-host”, “Dest_Host_IP”: “192.168.2.2”, “Dest_Host_Name”: “dest-host”, “VM_Ip”: “10.10.0.1”, “VM_Name”: “vm-name”, “VM_Vlan”: 500, “VM_IF_name”: “eth0/0”, “VM_Port_Profile_index”: 1234, “VM_MAC”: “11-22-33-cc-dd-ee”,}

“Version” denotes a version number, e.g., 1.0, 1.1, etc.

“Type” denotes a packet type. The value of this field may be 1 denoting that this is a VM migration report after the VM is migrated.

“Src_Host_IP” denotes the IP address of the physical server where the

VM is located before the migration.

“Src_Host_name” denotes the name of the physical server where the VM is located before the migration.

“Dest_Host_IP” denotes the IP address of the physical server where the VM is located after the migration.

“Dest_Host_name” denotes the name of the physical server where the VM is located after the migration.

“VM_IP” denotes the IP address of the VM.

“VM_Name” denotes the name of the VM.

“VM_Vlan” denotes a VLAN ID that the VM belongs to, the value range is

“VM_IF_Port” denotes a port ID of a switch that the VM accesses after the migration.

“VM_Port_Profile_index” denotes a Profile index of policies such as QoS of the port of the switch the VM accesses.

“VM_MAC” denotes the MAC address of the VM, the format is “xx-xx-xx-xx-xx-xx”.

The name of the physical server and the name of the VM may be used for providing explicit identifiers to administrators on an interface, since the IP addresses are not easy to be recognized. Not all of the above location parameters are required to be transmitted in the VM migration report. It may be determined by implementation manners of manufactures on the management plane which location parameter is transmitted.

At block 402, an old security device that the VM belongs to before the migration and a new security device that the VM belongs to after the migration are determined according to the location parameter of the VM and a locating function. In one example, a VM belongs to a security device if the security device controls what data can be sent to or received from or otherwise accessed by the VM.

According to the location parameter of the VM and the locating function, the locating module 32 determines the old security device and the new security device that the VM belongs to before and after the migration. In one example of the present disclosure, considering that the VM management apparatus and the VM security policy migration apparatus 10 are provided by different manufactures, the VM management apparatus may transmit more location parameters in the VM migration report in order to be more compatible with the VM security policy migration apparatus 10. Thus, the implementation of the locating module 32 becomes rather flexible. Locating modules 32 provided by different manufactures may use different locating functions. And different locating functions can use different kinds of location parameters.

For example, as shown in FIG. 2, the security management server saves

IP addresses of physical servers managed by each firewall. For example, the IP address segment of the physical servers managed by firewall 1 is 192.168.1.2-192.168.1.100. The IP address segment of the physical servers managed by firewall 3 is 192.168.1.101-192.168.1.200. Suppose that the IP address of the physical server where the VM is located before the migration is 192.168.1.20, and the IP address of the physical server where the VM is located after the migration is 192.168.1.120. Thus, the locating module 32 can know that the VM belongs to firewall 1 before the migration and belongs to firewall 3 after the migration.

For another example, suppose that the security management server saves network topology information of areas managed by each security device. The locating module 32 may determine that the port ID of the switch that the VM accesses or the VLAN ID that the VM belongs to in the VM migration report is included in the network topology information managed by which security device. Then, the locating module 32 may know the old security device and the new security device that the VM belongs to before and after the migration. For still another example, suppose that the security management server saves the network topology information of areas managed by each security device. The locating module 32 may determine from which switch that the VM accesses the network using MAC address locating techniques. Then, the locating module 32 may know the old security device and the new security device that the VM belongs to according to the network topology. Similarly, in a practical application of the locating module 32, other functions combined with different kinds of location parameters (or combinations of locations parameters) may be used for determine the security devices that the VM belongs to.

Furthermore, considering that the VM management apparatus and the

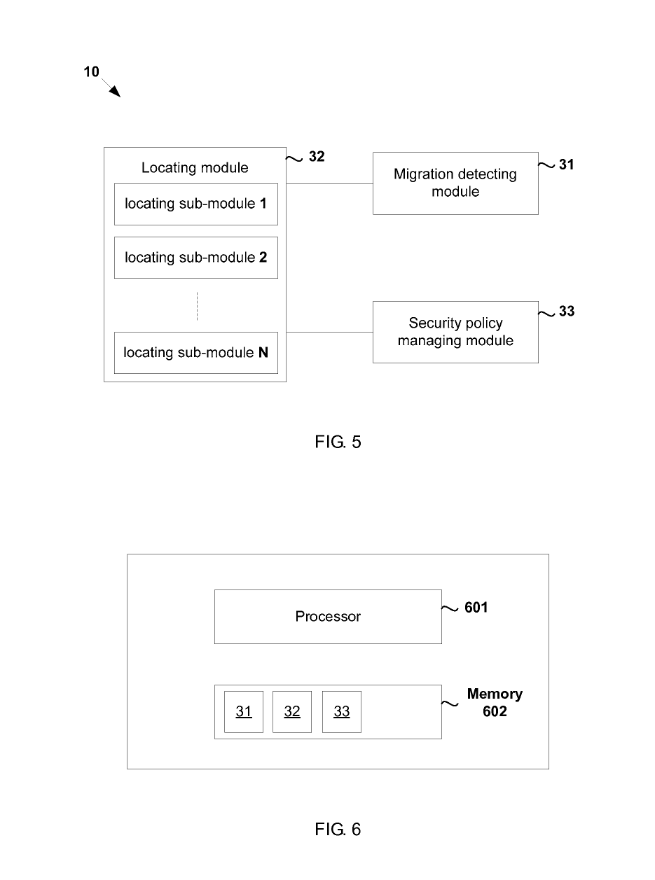

VM security policy migration apparatus 10 may be provided by different manufactures, a plurality of locating sub-modules may be configured in the locating module 32 for better compatibility (as shown in FIG. 5). The locating sub-modules respectively determine the security devices that the VM belongs to using different location parameters. In other words, even if the VM migration report transmitted by the VM management apparatus includes only a few kinds of location parameters, the locating module 32 is still able to determine the security devices that the VM belongs to based on multiple locating functions (i.e., the plurality of locating sub-modules configured). Similarly, although the VM migration reports transmitted by different VM management apparatuses may include different kinds of location parameters, the plurality of locating sub-modules can deal with the differences of the VM management apparatuses and have a better compatibility.

At block 403, it is determined whether the old security device and the new security device are the same security device. If the old security device and the new security device are the same, the flow is ended; otherwise, block 404 is performed.

In conventional data centers, one security device such as a firewall may manage a large area. Thus, it is possible that the security device that the VM belongs to does not change after the migration. Therefore, before further processing is performed, it is determines whether the security devices that the VM belongs to before and after the migration are the same, e.g., compare identifiers of the security devices. If they are the same, no further processing is done for VM security policy migration for the VM. If they are not the same, a notification may be transmitted to the security policy managing module 33 for further processing.

At block 404, a security policy of the VM on the old security device is obtained and issued to the new security device.

For example, there is a management tunnel between the security management server and each security device. The security policy managing module 33 may read the security policy configured for the VM on the old security device that the VM belongs to via the management tunnel and then issues the security policy to the new security device that the VM belongs to. The security policy of the VM on the old security device is also issued by the security policy managing module 33. Therefore, the security policy managing module 33 may save the security policy of the VM on the security management server. Thus, the security policy managing module 33 may also obtain the security policy of the VM on the old security device from the security management server. Since the new security device uses the same security policy with the old security device, the seamless migration of the security policy along with the migration of the VM is realized. The seamless migration has little impact on the service providing of the VM. External users visiting the VM may sense no changes of the VM. In addition, after the security policy is successfully issued to the new security device that the VM belongs to, the old security device does not require the security policy of the VM anymore. Therefore, the security policy managing module 33 may further remove the security policy on the old security device, e.g., delete or disable the security policy, so as to save spaces of the old security device and reduce service processing time of the old security device.

The VM security policy migration apparatus 10 may include a computer system as shown in FIG. 6. As shown in FIG. 6, the apparatus 10 includes: a processor 601 and a memory 602; wherein the memory 602 is communicatively connected to the processor 601 and stores machine readable instructions on a non-transitory computer readable medium (e.g., memory 602) executable by the processor 601 to receive a VM migration report from a VM management apparatus, wherein the VM migration report includes at least a location parameter of the VM, and the VM management apparatus is for creating and managing the VM; determine, according to the location parameter of the VM and a locating function, an old security device and a new security device that the VM belongs to before and after the migration; and determine whether the old security device and the new security device are the same security device, if the old security device and the new security device are not the same security device, obtain a security policy of the VM configured on the old security device and issue the security policy to the new security device. The migration detecting module 31, the locating module 32 and the security policy managing module 33 shown in FIG. 3 may comprise machine readable instructions stored in the memory 602 and executed by the processor 601.

The examples described above may realize the seamless migration of the security policy of the VM along with the migration of the VM through the VM security policy migration apparatus.

The above examples may be implemented by hardware, software, firmware, or a combination thereof. For example the various methods, processes and functional modules described herein may be implemented by a processor (the term processor is to be interpreted broadly to include a CPU, processing module, ASIC, logic module, or programmable gate array, etc.). The processes, methods and functional modules may all be performed by a single processor or split between several processors; reference in this disclosure or the claims to a ‘processor’ should thus be interpreted to mean ‘one or more processors’. The processes, methods and functional modules are implemented as machine readable instructions executable by one or more processors, hardware logic circuitry of the one or more processors or a combination thereof. Further, the examples disclosed herein may be implemented in the form of a software product. The computer software product is stored in a non-transitory storage medium and comprises a plurality of instructions for making a computer device (which may be a personal computer, a server or a network device, such as a router, switch, access point, etc.) implement the method recited in the examples of the present disclosure.

What has been described and illustrated herein is an example of the disclosure along with some of its variations. The terms, descriptions and figures used herein are set forth by way of illustration. Many variations are possible within the spirit and scope of the disclosure, which is intended to be defined by the following claims and their equivalents.

What is claimed is:

1. A Virtual Machine (VM) security policy migration apparatus comprising: a migration detecting module, a locating module and a security policy managing module; wherein
the migration detecting module is to receive a VM migration report from a VM management apparatus, wherein the VM migration report comprises a location parameter of a VM, and the VM management apparatus is to create and manage the VM;
the locating module is to determine, according to the location parameter of the VM and a locating function, an old security device and a new security device that the VM belongs to before and after the migration, determine whether the old security device and the new security device are the same security device; if the old security device and the new security device are not the same security device, transmit a notification to the security policy managing module; and
the security policy managing module is to obtain, after receiving the notification of the locating module, a security policy of the VM on the old security device and issue the security policy to the new security device.

2. The apparatus of claim 1, wherein the security policy managing module is further to remove the security policy on the old security device if the old security device and the new security device are not the same security device.

3. The apparatus of claim 1, wherein the location parameter of the VM comprises any one or any combination of: an Internet Protocol (IP) address of the VM, a Media Access Control (MAC) address of the VM, an IP address of a physical server where the VM is located before the migration, an IP address of a physical server where the VM is located after the migration, an access port ID of the VM before the migration, an access port ID of the VM after the migration, and an VLAN ID of the VM.

4. The apparatus of claim 1, wherein the locating module comprises a plurality of locating sub-modules, the plurality of locating sub-modules respectively use different locating functions, wherein the different locating functions determine the old security device and the new security device that the VM belongs to according to different location parameters or different combinations of the location parameters.

5. A method of Virtual Machine (VM) security policy migration comprising:
receiving a VM migration report from a VM management apparatus, wherein the VM migration report comprises a location parameter of a VM, and the VM management apparatus is to create and manage the VM;
determining, according to the location parameter and a locating function, an old security device and a new security device that the VM belongs to before and after the migration; and
determining whether the old security device and the new security device are the same security device; and
if the old security device and the new security device are not the same security device, obtaining a security policy of the VM on the old security device and issuing the security policy to the new security device.

6. The method of claim 5, further comprising:
if the old security device and the new security device are not the same security device, removing the security policy on the old security device.

7. The method of claim 5, wherein the location parameter comprises any one or any combination of: an Internet Protocol (IP) address of the VM, a Media Access Control (MAC) address of the VM, an IP address of a physical server where the VM is located before the migration, an IP address of a physical server where the VM is located after the migration, an access port ID of the VM before the migration, an access port ID of the VM after the migration, and an VLAN ID of the VM.

8. The method of claim 5, further comprising:
before determining the old security device and the new security device according to the location parameter and the locating function, selecting one locating function among multiple locating functions, wherein different locating functions determine the old security device and the new security device that the VM belongs to according to different location parameters or different combinations of location parameters.

9. A Virtual Machine security policy migration apparatus, comprising: a processor and a memory, wherein the processor is communicatively connected with the memory, the memory stores machine readable instructions executable by the processor to:
receive a VM migration report from a VM management apparatus, wherein the VM migration report comprises a location parameter of a VM, and the VM management apparatus is to create and manage the VM;
determine, according to the location parameter and a locating function, an old security device and a new security device that the VM belongs to before and after the migration;
determine whether the old security device and the new security device are the same security device; and
if the old security device and the new security device are not the same security device, obtain a security policy of the VM on the old security device and issuing the security policy to the new security device.
